(19) United States
(12) Patent Application Publication
(10) Pub. No.: US 2023/0066998 A1
(43) Pub. Date: Mar. 2, 2023

(54) Microwave System for Detection and Characterization of Fluidic Materials Interacting with Surfaces

(71) Applicant: Baylor University, WACO, TX (US)

(72) Inventors: Stephen T. MCCLAIN, Hewitt, TX (US); Brandon HERRERA, Portland, TX (US)

(73) Assignee: Baylor University, Waco, TX (US)

(21) Appl. No.: 17/823,166

(22) Filed: Aug. 30, 2022

Related U.S. Application Data
(60) Provisional application No. 63/239,207, filed on Aug. 31, 2021.

(51) Int. Cl. G01N 22/00; H01P 3/08

(52) U.S. Cl. CPC G01N 22/00; H01P 3/081

(57) ABSTRACT

The disclosure provides a microwave system developed to measure properties of fluidic materials incident upon a surface using a phase response of multiple microstrip transmission lines, generally over an ultra-wideband excitation. The system can include a series of parallel planar transmission lines as waveguides that are coupled to an insulator layer and a conductor as a formed-to-fit or flexible insulator layer, an ultra-wideband RF transceiver measuring phase angle, and a processing computer. The system can directly measure electrical permittivity in the microwave frequency band. This measurement can be processed to determine the presence of a homogeneous or heterogeneous fluidic material on a surface to which the transmission lines are coupled, the presence of a phase change in the fluidic material, and potentially the presence of other fluidic materials, depending on differences in permittivity between the fluid materials. In some embodiments, a thickness of the material can be also be provided.

### CROSS REFERENCE TO RELATED APPLICATIONS

This application claims the benefit of U.S. Provisional Patent Application Ser. No. 63/239,207, filed Aug. 31, 2021, entitled “Microwave System for Detection and Characterization of Materials Interacting with Aircraft and Airfoil Surfaces” and is fully incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure relates generally to using microwaves for detection and characterization of materials interacting with structures. More specifically, the disclosure relates to using microwaves for detection and characterization of fluidic materials, including ice and water interacting with surfaces, such as aircraft and airfoil surfaces.

### Description of the Related Art

Modeling Background for Multiphase Fluidic Materials

The accumulation of fluidic materials on a surface can affect the performance and at times safety of a structure. A prevalent example is found on aircraft and airfoil surfaces, although the principles apply to many other objects and surfaces. The local rate of water collection on an airfoil or aircraft surface is an important aspect of aircraft in-flight ice accretion. As an airstream with water droplets, or a cloud, flows around an airfoil, smaller droplets will move with the flow around the airfoil because of the local drag forces on the droplets. However, larger droplets may have sufficient inertia to resist abrupt changes in the flow direction, impinge the airfoil, and accumulate creating a solid film, a broken film, or a distribution of beads on the surface. For purposes herein, a solid film can be termed a “homogeneous” fluidic material, and a broken film or distribution of beads can be termed a “heterogeneous” fluidic material. Under certain conditions, the water, as a multi-phase material, can change to ice. An accumulation of ice negatively affects the airfoil lift characteristics and can lead to an inability for the aircraft to remain in flight, resulting in tragic impacts.

To help determine operating parameters for handling water and ice accumulation, current methods known as ice accretion codes use predictive modeling. As with most modeling, some error is possible and because of the severity of results from a failure, a margin of safety is considered in procedures and protocols. The margin of safety leads often to using unnecessary resources in attempting to avoid conditions that would affect the performance of the aircraft. Typical protocols allow an aircraft to be deiced with a spray-on chemical, such as a glycol based composition\, that reduces or prevents ice on an airfoil. The aircraft can be delayed from taking off beyond an allowed hold over time and has to return for de-icing, causing a delay in flights, loss of efficiency and schedules, and therefor loss of income for the airline.

Because of its importance in ice accretion prediction codes, measuring the local collection efficiency along an airfoil or ice shape surface has been the focus of many prior efforts. To measure the collection efficiency along different airfoils and artificial ice shapes, one approach has applied blotter paper to the airfoil and added blue dye to the water entering the spray bar system. Following actuation of a precise solenoid-valve controlled spray system, the amount of dye on the blotter paper can been measured using a reflectance spectroscopy system. While such measurements are enlightening and have provided substantial validation data for collection efficiency predictions in icing codes, the blotter paper approach is very tedious and difficult to implement and certainly not applicable for inflight use. The process also has challenges regarding splashing measurements, the data is not universally accepted, and collection efficiency data is needed for more modern airfoils to use the codes.

While modeling that directs the protocols provides a valuable tool, a better way is needed. A better way that determines an issue rather than just models the issue could drastically improve the safety and efficiency of handling the challenges of being safe and yet being efficient with resources.

### BRIEF SUMMARY OF THE INVENTION

The disclosure provides a microwave system developed to measure properties of fluidic materials incident upon a surface using a phase response of multiple microstrip transmission lines, generally over an ultra-wideband excitation. The system can include a series of parallel planar transmission lines as waveguides that are coupled to an insulator layer and a conductor as a formed-to-fit or flexible insulator layer, an ultra-wideband RF transceiver measuring phase angle, and a processing computer. The system can directly measure electrical permittivity in the microwave frequency band. This measurement can be processed to determine the presence of a homogeneous or heterogeneous fluidic material on a surface to which the transmission lines are coupled, the presence of a phase change in the fluidic material, and potentially the presence of other fluidic materials, depending on differences in permittivity between the fluid materials. In some embodiments, a thickness of the material can be also be provided. The invention significantly improves over the current state of fluidic determinations in difficult environments that heretofore have been relegated to modeling to predict the presence of the fluidic materials. Instead, the invention provides a system and method that can actually determine the presence of the fluidic materials and characteristics, generally in real time for real time decisions as appropriate.

In at least one embodiment, the invention can provide: the presence and amount of water collected on a surface for a liquid film thickness, the rate of water film thickness change in time, the ratio of the amount of water collected relative to the amount of water in a cloud that should impinge an equivalent projected area given a known air and cloud velocity for a surface collection efficiency; the amount of ice-treating (de-icing and/or anti-icing) fluid present and time when that fluid has runoff, defined as hold over time for aviation surfaces; the water fraction of ice-treating mixtures; the dilution fraction of ice-treating fluids (as fluidic materials) as they are contaminated by atmospheric precipitation such as rain and snow, and the thickness of ice buildup, defined as ice accretion. When an array of the planar transmission lines is employed with a multiplexing system, the system can be used to determine the surface variations of substances interacting with the transmission lines in the direction perpendicular to the parallel transmission lines or at each location of the transmission lines. In at least one embodiment, a transmission line on a formed-to-fit or flexible insulator layer allows the application of the sensing method on flat or curved surfaces without significant increase of the aerodynamic flow or frictional flow resistance of the surface. In addition to aviation surfaces, the approach is suitable for other structures having a fluidic flow across structural surfaces, including wind turbine, automotive, and naval surfaces, and advantageously where flush mounted sensors on flat or curved surfaces minimize frictional impact or changes in a typical flow of a fluid over the structural surface.

The disclosure provides a system for detecting and characterizing a fluidic material incident on a surface comprising: a sensor; an ultra-wideband radio frequency transmitter configured to transmit an electromagnetic wave into the transmission lines; an ultra-wideband radio frequency receiver configured to receive the electromagnetic wave from the transmission lines; and a processing computer configured to measure a phase response of a change in the electromagnetic wave between transmission and reception due to the presence of the fluidic material on the sensor. The sensor comprises at least two parallel co-planar transmission lines configured to guide a transmission of an electromagnetic wave; dielectric material configured to support the transmission lines in a mutual fixed relative position; and a conductive layer coupled to the insulator layer.

The disclosure also provides a method of using microwaves for detecting and characterizing a fluidic material incident on a surface comprising measuring properties of fluidic materials incident upon a surface using a phase response of a sensor comprising multiple microstrip transmission lines over an ultra-wideband excitation.

### BRIEF DESCRIPTION OF THE SEVERAL VIEWS OF THE DRAWINGS

FIG. 1A is a schematic representation of at least one transmission line coupled with a insulator layer and a conductive layer to form a circuit board as a waveguide sensor having field strength lines with no substantial amount of fluidic material on the surface.

FIG. 1B is a schematic representation of the sensor of FIG. 1A having magnetic field strength lines with a substantial amount of fluidic material on the surface.

FIG. 2 is an exemplary embodiment of an embodiment of the invention, illustrating multiple transmission lines on a surface prone to fluidic material impact.

FIG. 3 is an exemplary simplified block diagram of a system using the multiple transmission lines.

FIG. 4A is a photo of the fabricated transmission line constructed on an insulator layer and a conductive layer to function as a waveguide sensor.

FIG. 4B is a photo of test equipment coupled to the sensor of FIG. 4A.

FIG. 4C is a photo of an enlarged view of the sensor of FIG. 4A showing water beads on the transmission line.

FIG. 5 is a graph of results of testing the sensor in the embodiment of FIG. 4A.

FIG. 6 is a schematic perspective view of another embodiment of the waveguide sensor for fluidic material.

FIG. 7 is a graph of results of testing the sensor in the embodiment of FIG. 6.

FIG. 8 is a photo of an example of the waveguide sensor having multiple transmission lines mounted on a portion of an exemplary airfoil structure.

FIG. 9 is a graph of results of testing the sensor in the embodiment of FIG. 8.

FIG. 10 is a graph showing results using a blotter material procedure.

FIG. 11 is a schematic top view of a wind tunnel for testing and calibration of impingement to collection efficiency.

FIG. 12 is a schematic of an embodiment with a waveguide sensor as a probe having a fixed geometry useful for determining Liquid Water Content.

FIG. 13 is a photo of a laboratory test configuration for determining effectiveness of ice-treating fluids relative to time.

FIG. 14 is a graph of results of testing the sensor in the configuration of FIG. 13.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The terms “top”, “up”, “upward”, “bottom”, “down”, “downwardly”, and like directional terms are used to indicate the direction relative to the figures and their illustrated orientation and are not absolute relative to a fixed datum such as the earth in commercial use. The term “inner,” “inward,” “internal” or like terms refers to a direction facing toward a center portion of an assembly or component, such as longitudinal centerline of the assembly or component, and the term “outer,” “outward,” “external” or like terms refers to a direction facing away from the center portion of an assembly or component. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unitary fashion. The coupling may occur in any direction, including rotationally. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. Some elements are nominated by a device name for simplicity and would be understood to include a system of related components that are known to those with ordinary skill in the art and may not be specifically described. Some elements are nominated by a device name for simplicity and would be understood to include a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. As such, the use of the term “exemplary” is the adjective form of the noun “example” and likewise refers to an illustrative structure, and not necessarily a preferred embodiment. Element numbers with suffix letters, such as “A”, “B”, and so forth, or numbers with prime, double prime, and so forth, such as 1, 1′, 1″, and so forth, are to designate different elements within a group of like elements having a similar structure or function, and corresponding element numbers without the letters are to generally refer to one or more of the like elements. Any element numbers in the claims that correspond to elements disclosed in the application are illustrative and not exclusive, as several embodiments are disclosed that use various element numbers for like elements. Unless otherwise defined, all technical and scientific terms used herein have the same meaning as commonly understood by one of ordinary skill in the art to which this invention belongs. Although methods, materials, and/or systems similar or equivalent to those described herein can be used in the practice of the present disclosure, suitable methods, materials, and/or materials are described below. In addition, the methods, materials, and/or systems are illustrative and not intended to be limiting, unless stated otherwise. Publications, patents, and other references mentioned herein are incorporated by reference in their entirety; provided that in case of conflict, the present specification, including definitions, will control.

The disclosure provides a microwave system developed to measure properties of fluidic materials incident upon a surface using a phase response of multiple microstrip transmission lines, generally over an ultra-wideband excitation. The system can include a series of parallel planar transmission lines as waveguides that are coupled to an insulator layer and a conductor as a formed-to-fit or flexible insulator layer, an ultra-wideband RF transceiver measuring phase angle, and a processing computer. The system can directly measure electrical permittivity in the microwave frequency band. This measurement can be processed to determine the presence of a homogeneous or heterogeneous fluidic material on a surface to which the transmission lines are coupled, the presence of a phase change in the fluidic material, and potentially the presence of other fluidic materials, depending on differences in permittivity between the fluid materials. In some embodiments, a thickness of the material can be also be provided. The invention significantly improves over the current state of fluidic determinations in difficult environments that heretofore have been relegated to modeling to predict the presence of the fluidic materials. Instead, the invention provides a system and method that can actually determine the presence of the fluidic materials and characteristics, generally in real time for real time decisions as appropriate.

The invention is based on an application of determining permittivity of substances through reception of microwaves. For a better understanding of the invention, electromagnetic waves are influenced by two material properties, permittivity and permeability, which control signal loss and velocity of propagation through the material. As pertaining to fluids, for example, the polarity of liquid water contributes to a nearly two order of magnitude increase in its permittivity over that of free space and non-polar molecules and ice. This large difference facilitates microwave sensing of water in various mixtures and forms. The concepts applies to other fluidic materials as well.

Absolute permittivity is a measure of a dielectric material polarizability and is quantified by Farads per meter. Relative permittivity is defined as a scalar dimensionless number that is the absolute permittivity of a material relative to that of free space or a vacuum. References to permittivity of ratios herein are referring to relative permittivity. Relative permittivity of homogeneous dipole molecules varies over frequency and temperature. For example, at 10 GHz water's permittivity varies between 42.1 and 60.9 as temperature is increased from 0° C. to 20° C. Thus, significant temperature variations would require compensation.

The relative permittivity of air is dependent on pressure, temperature, and its water vapor density. The relative permittivity of air can be represented as a constant over frequency and is much lower than liquid water. At 0° C., the relative permittivity of air varies between 1.00056 and 1.00062 depending on humidity. However, changes in humidity make a small and often negligible impact in microwave sensing compared sensing of liquid water.

For mixtures and non-homogeneous materials, effective permittivity is used to describe the measurement environment. The effective permittivity is defined as the equivalent permittivity for which a homogeneous material would produce the same electromagnetic response. For example, the effective permittivity of the cloud mixture can be modeled by averaging the respective air and water permittivities based on volume of each substance present. For a very wet cloud, that is 0.5% water by volume at 0° C., the relative permittivity will be approximately 1.015, but even so is only 1.5% greater than that of air. This small difference in the cloud permittivity is more challenging to resolve and presents a negligible impact in the presence of liquid water. Planar microwave sensors are most sensitive to materials near their surface. Thus, the accumulation of millimeter scale liquid drops, beads, and film on the sensor face will be the dominating factor over the atomized cloud. Further, the accumulation does not require a continuous accumulation to be measured. Non continuous films, such as droplets on the sensor, can be measured.

An example of an ice-treating fluid, propylene glycol, exhibits a similar high frequency relative permittivity to that of water (4.1 compared to 4), but its low frequency permittivity is 30.2 with a relaxation frequency of 4.2 GHz. This equates to a 4 GHz upper limit for differentiation of glycol to water, but also allows for a second measurement above the relaxation frequency to determine total thickness on the sensor. Ice-treating mixtures use minimal amounts of water to have higher viscosities and thus larger holdover times.

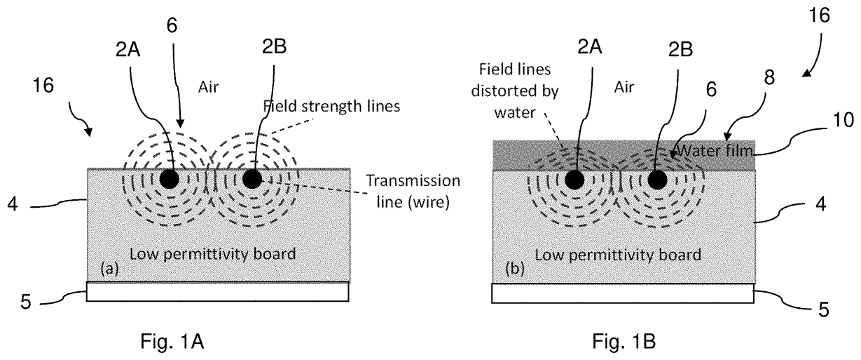

FIG. 1A is a schematic representation of at least one transmission line coupled with an insulator layer and a conductive layer to form a circuit board as a waveguide sensor having field strength lines with no substantial amount of fluidic material on the surface. In this embodiment, multiple transmission lines 2A and 2B (generally, “2”) are shown embedded in an insulator layer 4 with air above the surface and a conductive layer 5 distal from the transmission lines relative to the insulator layer for form a sensor 16. The transmission lines can include various types including planar transmission lines, microstrip lines, stripline, coplanar waveguide, balanced lines, and slotted lines. The insulator layer 4 can be dielectric material, ceramic material, or other materials having insulating qualifies. The conductive layer 5 can be a back layer to the dielectric material independent of the surface to be measured, or the conductive layer can be the surface material itself, if the surface is conductive, to which the insulator layer with the transmission lines can be coupled.

As alternating current flows through the transmission lines with a set frequency, electromagnetic fields are produced in the material and air. The concentric circles represent instantaneous magnetic field lines 6 created by the current in the transmission lines 2. The fields are generally around the transmission lines and thus to sense a surface in at least two dimensions, multiple transmission lines generally in parallel alignment are used to form an array. Because permittivity of air is similar that of a vacuum and the permittivity of the low permittivity board is in the range of 2 to 4, the magnetic fields generated by the transmission lines 2 are not significantly affected by the presence of the air or the board.

FIG. 1B is a schematic representation of sensor of FIG. 1A having magnetic field strength lines with a substantial amount of fluidic material on the surface. FIG. 1B presents the situation of FIG. 1A with the addition of a film of fluidic material, such as water, on the surface of the sensor. The fluidic material 8 that forms a film 10 on the sensor 16 has a significantly higher permittivity, and will distort the magnetic field lines 6′ of the illustrated two transmission lines 2. The stronger that the field is in the fluidic material 8, the more easily the film 8 can be measured.

As a signal is launched into the transmission lines 2, the high polarity, directly proportional to a high permittivity, of the fluidic material 8 will resist the changes in fields, which will slow the signal down. The units of permittivity is capacitance per meter, so the larger the permittivity, the more time it takes to figuratively charge a capacitor. This change in signal velocity will result in a phase-angle shift between the signal launched on the transmission line 2A and the signal measured coming from the transmission line 2B and vice versa. The amount of phase shift directly correlates to effective permittivity that is close to a volumetric average depending on the thickness of the film 10 for a given fluidic material 8. Once the relationship between volumetric average permittivity and phase shift is known, the data can be used to determine the amount of fluidic material that is present. The determination can be a calculation or a reference to a database based on a correlation. Alternatively, the data can be used in modeling equations to determine the amount of fluidic material that should be present. Further, the data with the empirically identified relationship can be used to refine the modeling equations for more accurate modeling results.

As aspect of the invention is to measure a delay in response (a change of phase) of an electromagnetic signal as it propagates down a dispersive microstrip transmission line. As the transmission line is exposed to fluidic materials incident on a surface, the signal will exhibit a short delay due to its now increased electrical energy storage capacity caused by the additive fluidic material on the surface. This increase in propagation time for the signal resulting in the change in phase is dependent on the effective permittivity of the material surrounding the line, particularly the fluidic material on the sensor. The larger the effective permittivity, the larger the delay, as electromagnetic propagation time is a function of the square root of its permittivity.

The delay caused by the change in effective permittivity can either be measured in the time domain with a pulsed excitation or in the frequency domain with sinusoidal excitation. Because the length of the transmission lines 2 are known, then the measurable increase in delay will be manifested by a phase shift between the launched wave and the measured output wave. The phase shift can be used to calculate the effective permittivity. From the effective permittivity, the amount of fluidic material present in the sensing volume may be determined.

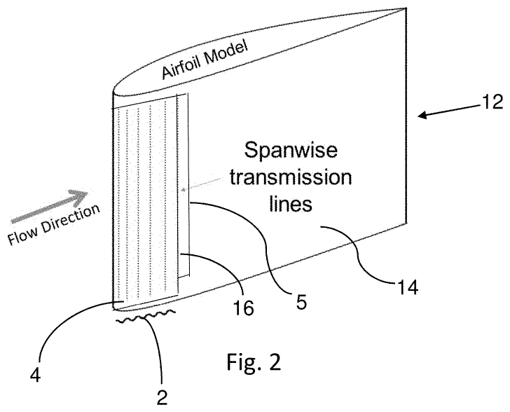

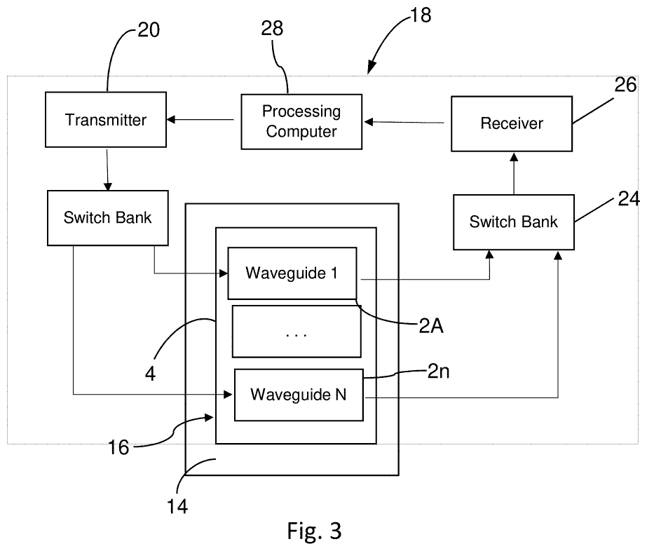

FIG. 2 is an exemplary embodiment of an embodiment of the invention, illustrating multiple transmission lines of a sensor on a surface prone to fluidic material impact. FIG. 3 is an exemplary simplified block diagram of a system using the multiple transmission lines. Multiple transmission lines 2 can be aligned on an insulator layer 4 with a conductive layer 5 as a sensor 16. The sensor 16 can be coupled to a surface 14 of an object 12, such as an airfoil. In FIG. 3, in at least one embodiment, the system 18 can include a transceiver 20, a switch bank 22 coupled to multiple transmission lines 2A-2n on the insulator layer 4 of the sensor 16 coupled to the object surface 14. Another switch bank 24 can be coupled distally from the switch bank 22 relative to the transmission lines, and another transceiver 26 can be coupled to the switch bank 22. The transceivers 20 and 26 can be coupled to a processor 28. The system 18 can include other components (not shown) such as instruments, output devices, or other devices as may be desired. Further, the system 18 can be further varied the components in FIG. 3, with the primary goal is processing changes in permittivity from the magnetic fields in the transmission lines cause by fluidic material.

A film of fluidic material formed on the surface 14 of the object 12 can correlate to a film of fluidic material formed on the insulator layer 4 of the sensor, in part due to the sensor being able to be thin. Experimental results show that a thickness of such a sensor can be about 0.020 inches (0.05 mm). It is understood that such a thin sensor has negligible performance effect on the surface 14. The transceivers 22 and 26 can alternate sending and receiving signals depending on the phase of the AC current. The switch banks 24 allow multiplexing between the multiple transmission lines 2 and can interrogate each transmission line. Alternatively, the same functionality could be implemented with multiple simultaneous transceivers without the switch banks to increase response speed. Because an ultra-wideband phase response is appropriate, the transceivers could utilize either a time domain pulse or a frequency domain sweep.

In some embodiments, the senor 16 with the transmission lines 2 can be a length fully covering the surface 14 on which the fluidic material can impinge or otherwise collect. In other embodiments, the transmission lines 2 can be only a length sufficient for localized sensing at one or more specific areas of interest along the surface. Further, in some embodiments, wiring for coupling to the sensor can be externally coupled along the object to a controller, processor, instrument, output device, or other device of the system 18. In other embodiments, the wiring coupling with the sensor can be placed through an opening in the surface 14 to an inner volume in the object 12 and away from an external environment.

The information from the transmission lines can be used to indicate the actual presence of the fluidic material. In multi-phase materials, the information can be used to indicate when the fluidic material has changed phase, for example water to ice and vice versa. The information can also be used to improve and refine predictive modeling for more accurate predictions after correlations with the actual existence and volume or thickness of the fluidic material and perhaps the timing of occurrence of the fluidic material on the surface under given environmental, ambient, or other conditions.

Experiment 1

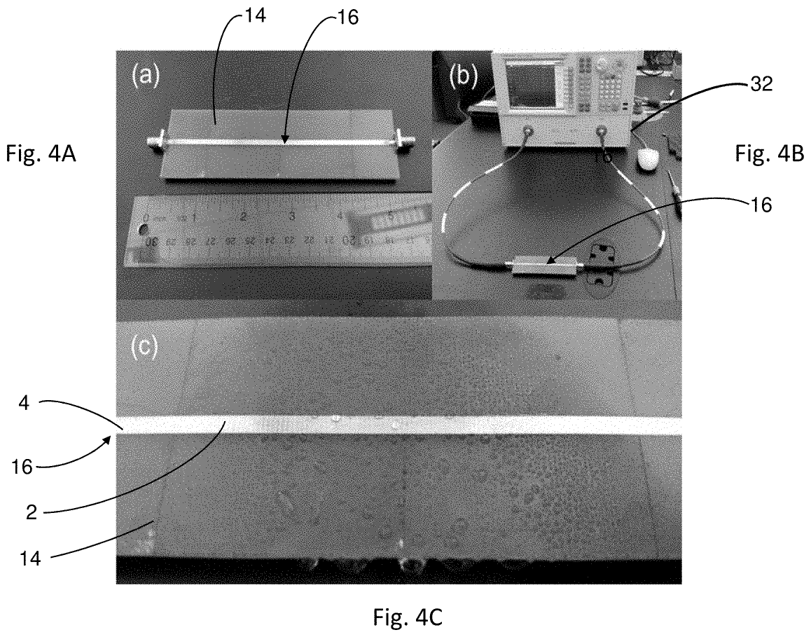

The transmission line 2 was fabricated using a laser system and tested. FIG. 4A is a photo of the fabricated transmission line constructed on an insulator layer and a conductive layer to function as a waveguide sensor. FIG. 4B is a photo of test equipment coupled to the sensor of FIG. 4A. FIG. 4C is a photo of an enlarged view of the sensor of FIG. 4A showing water beads on the transmission line. A sensor 16 formed with an insulator layer 4 having a transmission line 2 was placed on a surface 14. The example of a transmission line 2 was about 5 inches long, and the length can vary according to the desired size of surface area input. The sensor 16 was connected to a laboratory grade vector network analyzer 32 having a processor and output device. An airbrush was used to apply water to the sensing area that created discrete water beads over the top of the sensor 16 and surface 14 after a 1-second spray.

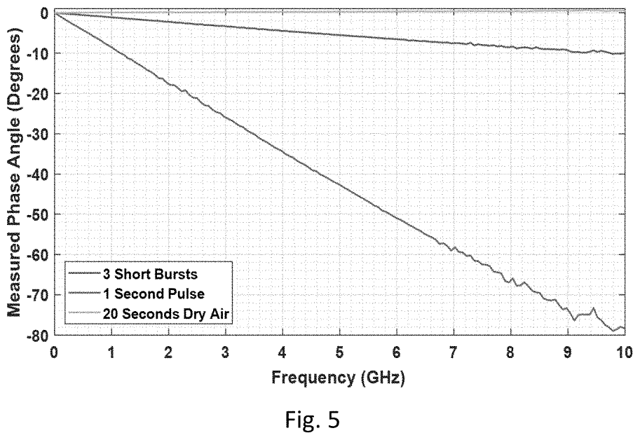

FIG. 5 is a graph of results of testing the sensor in the embodiment of FIG. 4A. FIG. 5 shows the measured phase-angle shift for a range of signal frequencies launched into the sensor. The phase angle shifts following: 1) three very short spray bursts, 2) a 1-second pulse, and 3) a 20-second spray of dry air. The lower curve in FIG. 5 corresponds to the condition shown in FIG. 4C. FIG. 5 and FIG. 4C demonstrate the high sensitivity of the transmission line 2 to small amounts of water in close proximity to the sensor. The graph also demonstrates the lack of significant drift or hysteresis based on the result that following the 20-second spray of dry air, the sensor phase-angle shift returns to a near zero value over the frequency range investigated. The graph further demonstrates that the sensor has a robust range of sensitivities versus frequency. That is, the higher frequencies may be used to sense very small amounts of water, but will be more susceptible to changes in drop or bead size. Thus, lower frequencies could be employed to obtain a response that is more stable for longer cloud accumulation times.

Experiment 2

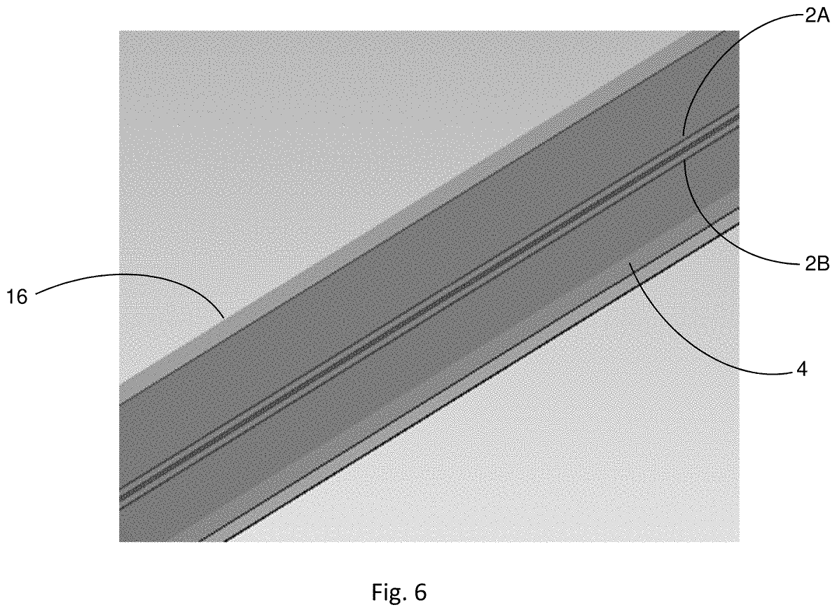

FIG. 6 is a schematic perspective view of another embodiment of the waveguide sensor for fluidic material. In this embodiment, a single planar differential waveguide sensor 16 having a pair of spaced transmission lines 2A and 2B as microstrips on an insulator layer 4 that can be used to measure differential impedance. A simulation was also conducted using the differential sensor with a thin film of water. While discrete beads or broken films may be expected in the planned sensor usage, the idealization of a continuous thin film is employed for simulation geometry purposes.

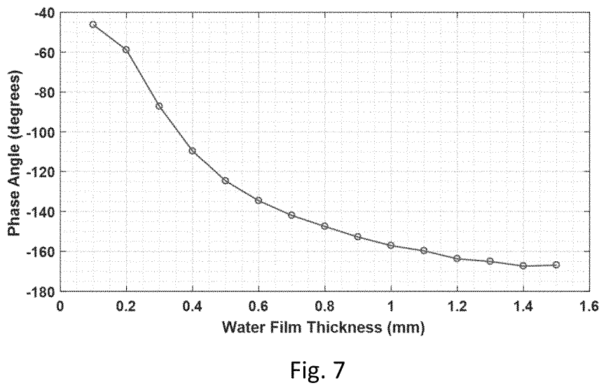

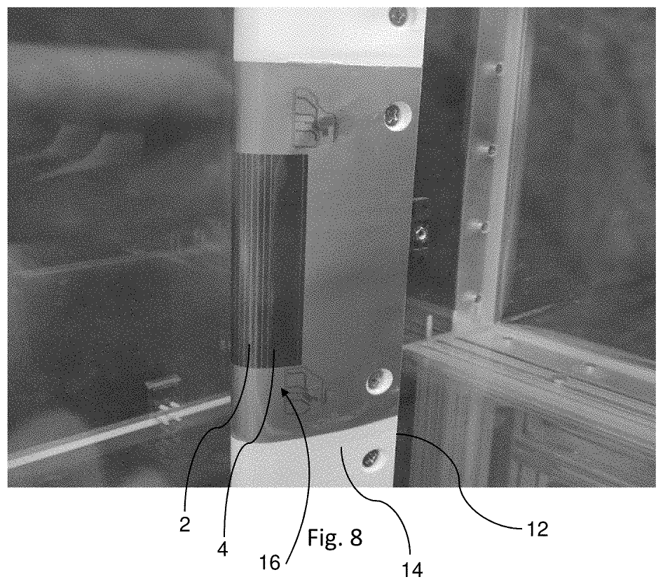

FIG. 7 is a graph of results of testing the sensor in the embodiment of FIG. 6. The results are of a simulation at 1 GHz as the thickness of the water film was varied from 0.1 mm. to 1.5 mm. A total phase shift difference of nearly 120 degrees was exhibited across the range of thickness values. The simulation results of FIG. 7 demonstrate the high sensitivity of the phase angle measurements to very small amounts of water near the sensor.

As can be seen above, the sensor senses permittivity. The existence of permittivity is not dependent on any particular fluidic material. Thus, the fluidic material could be generally any fluid for any purpose that exhibits detectable permittivity.

The information from the sensor can be used for determining the presence of undesired and desired fluidic materials such as the water or ice presence. The information from the sensor can be used to determine metrics for structures that are significantly affected by the presence or absence of fluidic materials. For example, certain metrics as collection efficiency of a surface passing through conditions with water droplets that impinge the surface of structure is important. A determination of Liquid Water Content is important in a number of fields, including weather forecasting. The information can be used to determine an important changing state of a fluidic material based on time, pressure, or other conditions. As an example, ice-treating fluid that flows from the surface leaving a decreasing remainder on the surface will degrade in protective ability with the passage of time. Operators at airports, airlines, and maintenance personnel can benefit by a more accurate determination whether an airplane needs ice-treating fluid. While current predictive models might predict a need, the actual existence of the need from the waveguide information, or indicate no ice-treating fluid is needed. In some aircraft, a ice-treating fluid is periodically distributed along the airfoil to reduce any accumulation of ice. The information provided based on permittivity can direct the distribution to occur when there is a need for the ice-treating and conserve resources when there is not a need.

Collection Efficiency

FIG. 8 is a photo of an example of the waveguide sensor having multiple transmission lines mounted on a portion of an exemplary airfoil structure. The sensor 16 with the insulator layer 4 having transmission lines 2 is mounted on a surface 14 of an object 12, which in this example is a representative airfoil portion. Direct sampling of collection efficiency of an airfoil requires a fast actuated spray tunnel. Precise control of the spray bar system is needed, because the surface is exposed to a simulated cloud for a fixed time allowing water to collect on the surface in sufficient volume to be measured but not run back along the surface. Data using this embodiment can be acquired one spray at a time for each sensor. A spray pulse train can be used to automate sampling of each sensor element, but the duty cycle of the train must be low enough to allow for the complete drying of the sensor.

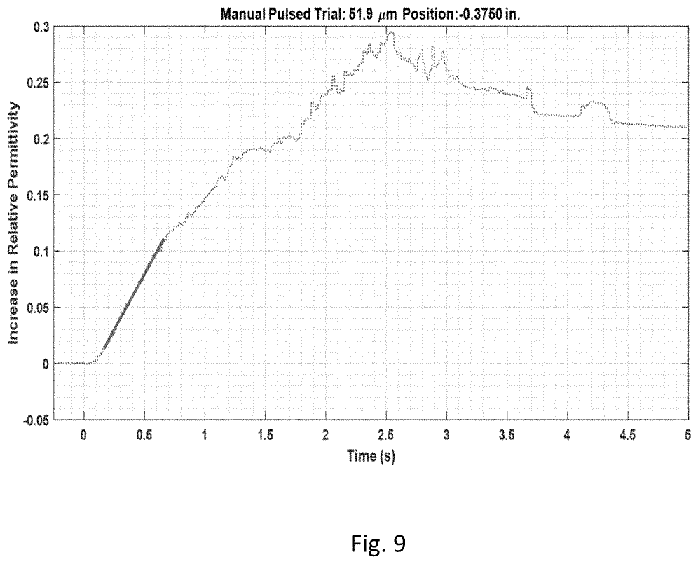

FIG. 9 is a graph of results of testing the sensor in the embodiment of FIG. 8. Given the phase delay, the average group delay can be computed using the derivative of the phase with respect to frequency. Increase in the relative permittivity can then be calculated using the delay of the sensor when dry. During the initial spray on a time basis, the slope of a line of best fit to the increase in permittivity with respect to time will produce the amount of water impinging on the surface as shown in FIG. 9.

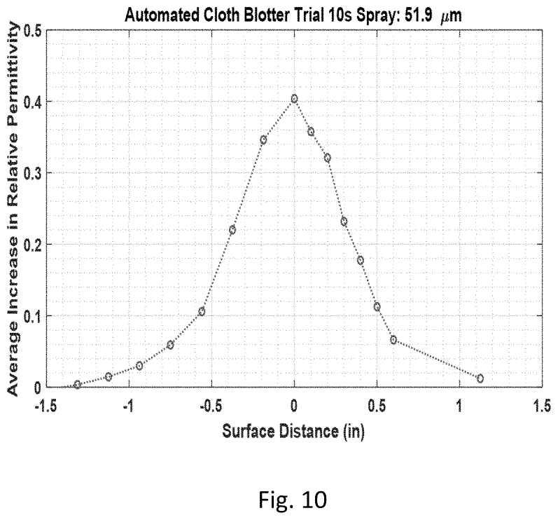

FIG. 10 is a graph showing results using a blotter material procedure. Alternatively, a blotter material of paper or cloth could be placed over the sensor 16 to imitate previous collection efficiency modeling measurements such as with a NACA-0012 Model using blotter cloth. The spray system still needs to be actuated, but the time of spray is limited to the blotter material's liquid saturation instead of avoiding runback along the airfoil. In prior standard methods, the blotter paper must be removed and laser scanned after using dyed water. With the invention, the moisture content of the paper can be measured in-situ after the spray has completed. The increase in effective permittivity can be used directly to determine how much water content was absorbed by the blotter material. Surface collection efficiency can then be produced as shown in FIG. 10. Calibration of impingement to collection efficiency can be accomplished with the laser scanning or image analysis approach to determine the amount of captured dye that was employed.

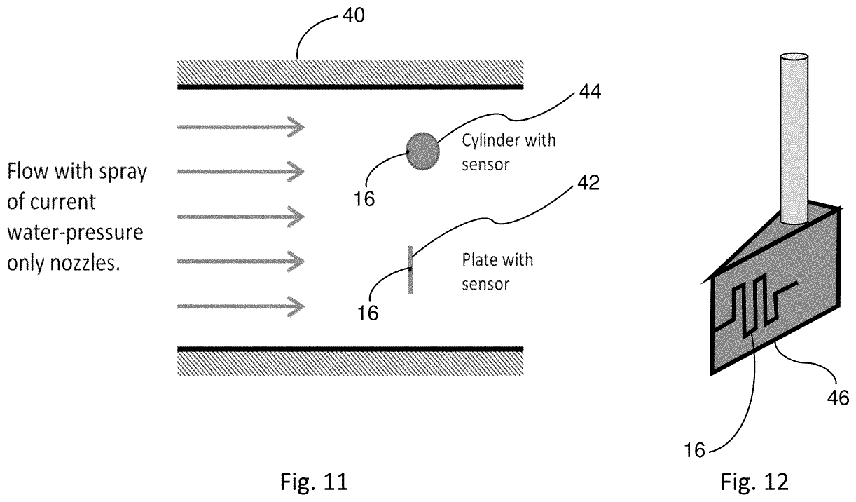

FIG. 11 is a schematic top view of a wind tunnel for testing and calibration of impingement to collection efficiency. A second calibration approach is a comparative test using a flat plate 42 perpendicular to the flow and a cylinder 44. Measurements using the sensor 16 on the plate should exhibit a high collection efficiency, and the collection efficiency of the cylinder with a sensor 16 with a known diameter is predictable based on known methods.

Liquid Water Content

FIG. 12 is a schematic of an embodiment with a waveguide sensor as a probe having a fixed geometry useful for determining Liquid Water Content. Liquid Water Content (“LWC”) is the measure of the mass of the water in a cloud in a specified amount of dry air. LWC assists in predicting which types of clouds are likely to form and is useful for weather forecasting. Using the teachings of the invention herein, LWC can be measured by applying the planar sensor 16 to a probe 46 of fixed geometry, such as the triangular object in FIG. 12. Standing liquid film thickness can be measured from the phase delay while under a continuous spray. An increase in effective permittivity is calculated as described herein to produce the thickness of the liquid film on the surface of the probe. In the measurement of LWC, the velocity and temperature of the cloud and airflow are useful. Thus, the embodiment could be employed with 1) a hot-wire, hot-film, Pitot-static probe, or other flow velocity probe, and 2) a thermocouple or alternative temperature measurement device.

Ice-Treating Fluids

Continuous permittivity measurements can detect the increase in permittivity due to de-icing and anti-icing fluidic materials such as propylene glycol mixtures, including DowFrost™. Glycol mixtures are typically used as ice-treating fluids, because they reduce the phase change temperature of water. When the ice-treating fluids are sprayed onto surfaces, such as airplanes, they begin to drain from the surfaces, causing the surfaces to progressively lose the protection from ice accumulation for the surfaces as time passes from the spraying. The permittivity measurements produced using the invention may be used to determine the remaining ice-treating fluid on the surface and identify a level of protection from ice accretion provided by the remaining ice-treating fluid on the surfaces.

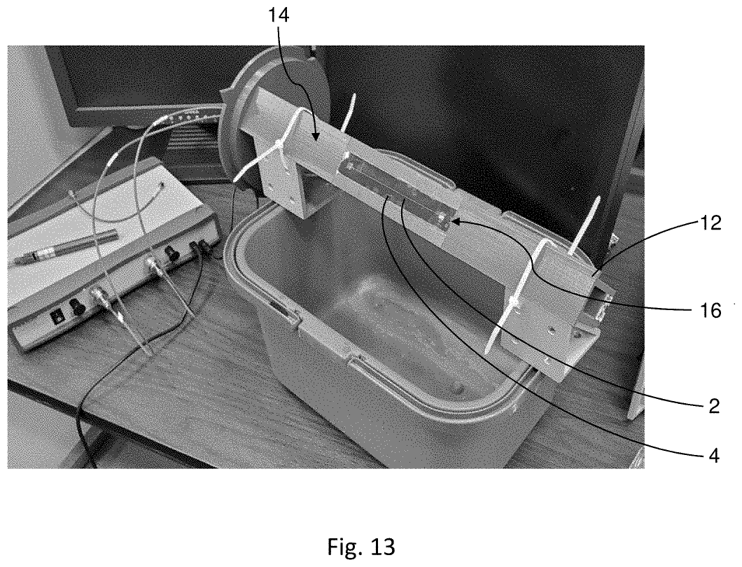

FIG. 13 is a photo of a laboratory test configuration for determining effectiveness of ice-treating fluids relative to time. The test configuration uses the sensor 16 that has been attached to a flat surface 14 of an object 12 to demonstrate the measurement of ice-treating fluid thickness decay time. The flat surface 14 is tilted at a 45° angle for runoff. The test configuration is used to demonstrate the sensor response to a single 1-second pulse of 60% propylene glycol-water mixture on the surface 14. This information can then be used to determine if a sufficient quantity of remaining ice-treating fluid is present. The sensor can also indicate when the ice present to be removed to alert of the need. In some automatic embodiments, the alert can activate fluid to be placed on the affected area for treatment of the ice. The sensor can also indicate when the ice has been removed or at least diminished to provide an ice removal indication. Thus, if ice is known to be present, the surface can be deiced. When the sensor indicates a drastically higher permittivity, that indicates that the ice has been removed from the surface (and they can stop spraying and wasting deicing fluid).and when the ice has been removed.

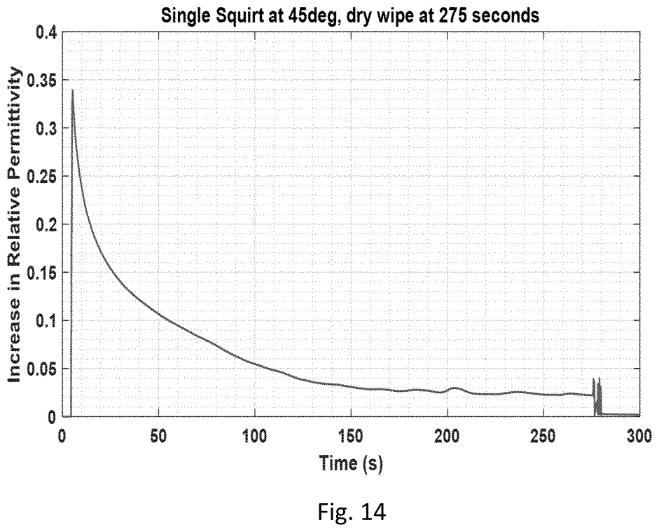

FIG. 14 is a graph of results of testing the sensor in the configuration of FIG. 13. In this test, the permittivity and therefore the thickness falls to about 15% of the initial protection in 100 seconds, or about 1½ minutes.

Other applications can occur for roadway transportation, such as bridges and overpasses. When the system with the sensor indicates an accumulation of ice on the roadway, the information can be sent to personnel to conduct roadway clearance measures, such as spreading ice-treating fluids and other measures, or actuating a roadway signage to warn of actual ice conductions. Further applications can include residential or industrial applications for the system to determine existence of fluid leaks on a particular surface that needs maintenance and correction, level gauges, and reclaimed deicing fluid composition.

Unless otherwise defined, all technical and scientific terms used herein have the same meaning as commonly understood by one of ordinary skill in the art to which this invention belongs. Although methods and materials similar or equivalent to those described herein can be used in the practice or testing of the present disclosure, suitable methods and materials are described below. All publications, patents, and other references mentioned herein are incorporated by reference in their entirety. In case of conflict, the present specification, including definitions, will control. In addition, the materials, methods, and examples are illustrative and not intended to be limiting.

Other and further embodiments utilizing one or more aspects of the invention described above can be devised without departing from the spirit of Applicants' invention in keeping within the scope of the claims.

The invention has been described in the context of preferred and other embodiments and not every embodiment of the invention has been described. Obvious modifications of the methods and systems include variations that an ordinary person skilled in the art would envision, given the teachings herein. The disclosed and undisclosed embodiments are not intended to limit or restrict the scope or applicability of the invention conceived of by the Applicant, but rather, in conformity with the patent laws, Applicants intend to protect fully all such modifications and improvements that come within the scope of the following claims.

What is claimed is:

1. A system for detecting and characterizing a fluidic material incident on a surface comprising
a sensor comprising:
at least two parallel co-planar transmission lines configured to guide a transmission of an electromagnetic wave;
insulator material configured to support the transmission lines in a mutual fixed relative position; and
a conductive layer coupled to the insulator layer; and
an ultra-wideband radio frequency transmitter configured to transmit an electromagnetic wave into the transmission lines;
an ultra-wideband radio frequency receiver configured to receive the electromagnetic wave from the transmission lines; and
a processing computer configured to measure a phase response of a change in the electromagnetic wave between transmission and reception due to the presence of the fluidic material on the sensor.

2. The system of claim 1, wherein the processing computer is further configured to correlate properties of the fluidic material on the surface using the phase response from the at least two parallel co-planar transmission lines over an ultra-wideband excitation.

3. The system of claim 1, further comprising a controller configured to switch between the transmission lines for transmission and reception of at least one electromagnetic wave.

4. The system of claim 1, wherein the parallel planar transmission lines are configured in an array.

5. The system of claim 1, wherein the parallel planar transmission lines are coupled to a flexible insulator layer.

6. The system of claim 1, wherein the surface comprises at least one of an aircraft, wind turbine, automotive, and naval surface.

7. The system of claim 1, wherein the transmitter, the receiver, or both comprise a transceiver.

8. The system of claim 1, wherein the conductive layer is configured to be coupled to coupled to the surface.

9. A method of using microwaves for detecting and characterizing a fluidic material incident on a surface comprising:
measuring properties of fluidic materials incident upon a surface using a phase response of a sensor comprising multiple microstrip transmission lines.

10. The method of claim 9, further comprising correlating properties of the fluidic material on the surface using the phase response from the at least two parallel co-planar transmission lines over an ultra-wideband excitation.

11. The method of claim 9, further comprising switching between the transmission lines for transmission and reception of at least one electromagnetic wave.

12. The method of claim 9, further comprising coupling the sensor to the surface for the measuring.

13. The method of claim 9, wherein measuring properties comprises at least one of:
measuring a presence and amount of liquid collected on the surface;
measuring a rate of liquid film thickness change in time;
measuring a ratio of the amount of liquid collected relative to the amount of liquid in a surrounding environment that should impinge an equivalent projected area;
measuring an amount of a reacting fluid that is present on the surface that is configured to lower a temperature of a phase change of the liquid to a solid;
measuring a dilution fraction of the reacting fluid as the reacting fluid is contaminated by environmental exposure to other fluids;
measuring a thickness of the fluidic material after a phase change in material; and
measuring a composition of an ice-treating fluid with amounts of corrosion inhibitors and rheological modifiers.
